(19) United States
(12) Patent Application Publication
(10) Pub. No.: US 2014/0139651 A1
(43) Pub. Date: May 22, 2014

(54) NAKED-EYE 3D TV WALL

(71) Applicants: Taiping Jiang, ChangSha (CN); Yangzhou Du, ChangSha (CN)

(72) Inventors: Taiping Jiang, ChangSha (CN); Yangzhou Du, ChangSha (CN)

(73) Assignee: Celvision Technologies Limited, Hunan Province (CN)

(21) Appl. No.: 14/116,833

(22) PCT Filed: Jun. 24, 2011
(86) PCT No.: PCT/CN2011/001053

§ 371 Date: Jan. 20, 2014

(30) Foreign Application Priority Data
May 10, 2011 (CN) 201110119344.0

(51) Int. Cl. H04N 13/04

(52) U.S. Cl. CPC H04N 13/0404; H04N 13/0422
USPC 348/52

(57) ABSTRACT

A naked-eye 3D TV wall is disclosed, which is composed of a full-color light-emitting diode (LED) display array and a slit grating (or a cylinder lens grating). The grating is placed in front of and parallel to the array, and a distance is made between the grating and the array. The grating direction of the array is provided as an oblique angle. A red, green and blue color LED tube are packed into one tube to make a full-color LED tube to emit full-color light, and the full-color LED tube is the element unit of the array. When a multi-view image is interlaced and displayed on the array, the resolution loss is shared in the horizontal and vertical directions. A 3D image will be watched on the wall without wearing special glasses.

### TECHNICAL FIELD

The present invention relates to a stereoscopic display field, in particular to a naked eye 3D (three-dimensional) TV wall implemented by using full color light emitting diode arrays.

### BACKGROUND

In recent years, with the development of the liquid crystal display technology, the naked eye 3D (three-dimensional) display technology, or the auto stereoscopic display technology, has achieved great improvements. The principle of the naked eye 3D display technology is to send the images with tiny parallaxes displayed on the display panel to the left eye and the right eye of the observers respectively by means of light obscuration or light refraction etc. Then the images with tiny parallaxes are merged in the observer's brain so as to generate a stereoscopic perception. Nowadays, the naked eye 3D display technology is implemented by the optical gratings. Because there is a certain tilt angle between the placement of the optical gratings and the column direction of the pixels, the loss of the display resolution is allowed to be decomposed into the horizontal direction and the vertical direction. However, the stereoscopic effect is implemented by the optical gratings in combination with the LCD liquid crystal screen, and then the size of the optical gratings is limited by the size of the LCD liquid crystal screen. So the optical gratings can not meet the requirements of stereoscopic display with a larger size.

### SUMMARY OF THE INVENTION

The technical problem to be resolved by the present invention is to provide a naked eye 3D TV wall, which allows an observer to observe 3D images on the TV wall without wearing special glasses.

The technology solution of the present invention to resolve the above technical problems is as follows: a naked eye 3D TV wall, wherein the naked eye 3D TV wall consists of full color LED display arrays and optical gratings; wherein, the optical gratings are placed in front of the full color LED display arrays, parallel to the full color LED display arrays, and keep a certain distance away from the full color LED display arrays; there is a tilt angle between the direction of the optical gratings and the column direction of the full color LED display arrays; when the images with multiple viewing angles are stagger mixed and then are displayed on the full color LED arrays, the loss of the display resolution is allowed to be decomposed into the horizontal direction and the vertical direction; and thus, the observer can watch 3D images on the TV wall without wearing special glasses.

The beneficial effect of the present invention is in that: because the optical gratings are placed in front of the full color LED display arrays, parallel to the full color LED display arrays, and keep a certain distance away from the full color LED display arrays, and there is a tilt angle between the direction of the optical gratings and the column direction of the full color LED; correspondingly, when the images with multiple viewing angles are stagger mixed and then are displayed on the full color LED arrays, the loss of the display resolution is allowed to be decomposed into the horizontal direction and the vertical direction, because of the obscuration effect or the refraction effect of optical gratings, the observers can watch 3D images on the TV wall without wearing special glasses.

Based on the above technical solution, the present invention can also be made the following improvements:

Further, the stagger mixing of the images with multiple viewing angles can be implemented in the following way:

Because there is a tilt angle between the direction of the optical gratings and the column direction of the full color LED, the loss of the display resolution is allowed to be decomposed into the horizontal direction and the vertical direction.

Assuming using an image with K viewing angles, K can be decomposed into M×N, supposing M is an integer, 1<M<K, N=K/M; and then a corresponding stagger mixing mode of images with multiple viewing angles, and corresponding parameters of the optical gratings are generated; thus, the resolution of stereoscopic display on the vertical direction is reduced to 1/M of the original value, and the resolution on the horizontal direction is reduced to 1/N of the original value, and the total resolution is reduced to 1/(M×N)=1/K of the original value;

Then, the stagger mixing of the images with multiple viewing angles could be implemented according to the following way: along the row direction of the LEDs, the pixels of adjacent LED tubes come from the images, the angle between which is equal to M parallax angles. Along the column direction of the LEDs, the pixels of adjacent LED tubes come from the images, the angle between which is equal to one parallax angle.

Further, when the ratio of the horizontal spacing and the vertical spacing of the LED tubes of the display arrays is r, the angle between the optical gratings and the column direction of the LED arrays should be α=tan⁻¹(r/M) so as to ensure that the pixels observed through the optical gratings are from images with the same viewing angle;

Then, in this case, the magnification factor is

$$m = \frac{WM}{{p}_{h}} ,$$

wherein, W is the distance between observer's two eyes, and Pₕ is the spacing in the row direction between adjacent LED tubes.

Further, the width of a cell of the optical gratings is

$${p}_{μ} = \frac{m}{m + 1} \frac{{p}_{h}}{M} K cos α .$$

Further, the distance between the observer's two eyes takes W=65 mm.

Further, the basic unit of LED display arrays is a full color LED tube. Wherein, the full color LED tube is formed by packaging three LED tubes, each of which presents one single color—Red, Green or Blue, into one tube, and it may emit full color lights.

Further, the LED tubes are arranged equidistantly and regularly in the display arrays along the horizontal direction and the vertical direction.

Further, the optical gratings in front of the LED display arrays are slit gratings or lenticular gratings.

Further, the slit gratings or lenticular gratings are placed in front of the LED display arrays in parallel. When the distance between optical gratings and the LED display arrays is d, the viewing distance for the naked eyes to get an optimal stereoscopic effect is D=m×d wherein, m is the magnification factor.

### BRIEF DESCRIPTION OF THE DRAWINGS

FIG. 1 is a schematic diagram of a detailed embodiment of the naked eye 3D TV wall implemented by full color LED arrays;

FIG. 2 is a schematic diagram illustrating an structural design of the optical gratings and a stagger mixing mode of images with multiple viewing angles in the case of 5 viewing angles.

FIG. 3 is a schematic diagram illustrating an structural design of the optical gratings and a stagger mixing mode of images with multiple viewing angles in the case of 8 viewing angles.

### DETAILED DESCRIPTION OF PREFERRED EMBODIMENTS

With reference to the accompanying drawings, the description of the principles and features of the present invention are given as follows, the given examples are only applied to illustrate the present invention, but not be applied to limit the scope of the present invention.

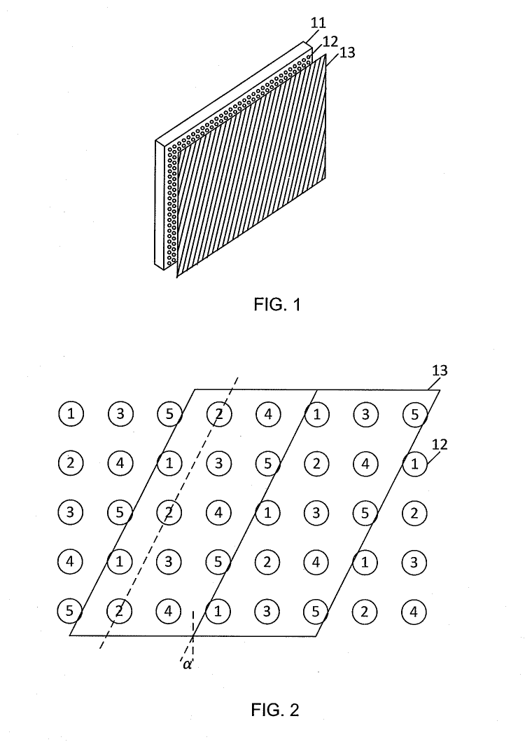

FIG. 1 is a schematic diagram of a detailed embodiment of the naked eye 3D TV wall implemented by full color LED arrays; wherein, 11 are full color LED display arrays, 12 is a full color LED tube, 13 are optical gratings, such as slit gratings or lenticular gratings etc,

As shown in FIG. 1, the naked eye 3D TV wall of the present invention consists of full color LED display arrays 11 and optical gratings 13. And the optical gratings 13 are placed in front of the full color LED display arrays 11, parallel to the full color LED display arrays 11, and keep a certain distance away from the full color LED display arrays 11. There is a tilt angle between the direction of the optical gratings and the column direction of the full color LED display arrays. When the images with multiple viewing angles are stagger mixed and then are displayed on the full color LED arrays, the loss of the display resolution is allowed to be decomposed into the horizontal direction and the vertical direction. Thus, the observer can watch 3D images on the TV wall without wearing special glasses.

The optical gratings 13 of the present invention can be implemented by slit gratings or lenticular gratings. The basic unit of LED display arrays is a full color LED tube. And the full color LED tube is formed by packaging three LED tubes, each of which presents one single color—Red, Green or Blue, into one tube, and the full color LED tube may emit full color lights. The benefits of using the full color LED tubes are that one colorful pixel can be displayed by only one LED tube, but not three LED tubes. In the case of the same density of the LED arrangements, full color LED tubes may provide a display resolution as big as at least three times of the display resolution of LED tubes each with a single color. As a 2D display shown, the full color LED tubes are arranged equidistantly and regularly in the LED display arrays of the naked eye 3D TV wall respectively along the horizontal direction and the vertical direction.

The technologies of slit gratings and lenticular gratings also can be used to the LED TV wall to generate a 3D display effect for the naked eyes. And a LED TV wall can be generated at any size according to the actual requirements. We know that one pixel on the liquid crystal panel consists of three sub-pixels—Red, Green and Blue. Similarly, when one basic display unit on the LED display arrays is a set of LED tubes consisting of three LED tubes three LED tubes, each of which presents one single color—Red, Green or Blue, a stagger mixing of the images with multiple viewing angles and a structural design of optical gratings are different in comparison with that applied on a liquid crystal panel. However, the new technology can package three LED tubes, each of which presents one single color—Red, Green or Blue, into one tube in order to form one full color LED tube. Thus, In the case of the same density of the LED arrangements, the display arrays implemented by full color LEDs can provide a display resolution at least three times higher than the display resolution of LED tubes each with a single color. Thus, we need a new stagger mixing mode of images with multiple viewing angles, and a new structure design of the optical gratings.

A 3D display effect for the naked eyes is implemented by the optical gratings 13 (slit gratings or lenticular gratings). The optical gratings are placed so as to parallel to the LED display arrays, and keep a distance away from the plane of the arrays. When the images with multiple viewing angles are stagger mixed and then are displayed on the full color LED arrays, because of the obscuration effect or the refraction effect of optical gratings, the left eye and the right eye of the observer watch different images so as to form a stereoscopic image in the brain. Since there is a tilt angle between the grating and the column direction, and the loss of resolution of the LED display will also be decomposed into the horizontal direction and the vertical direction.

The stagger mixing of the images with multiple viewing angles can be implemented by the following ways:

Because there is a tilt angle between the direction of the optical gratings and the column direction of the display arrays of the full color LED tubes, the loss of the display resolution is allowed to be decomposed into the horizontal direction and the vertical direction. Assuming, using an image with K viewing angles, K is a product of N and M, that is M×N; supposing M is an integer, 1<M<K, then N=K/M, (and N can be an integer or not an integer). In this way, you can get a corresponding stagger mixing mode of images with multiple viewing angles and corresponding parameters of the optical gratings. Thus, the stereoscopic display resolution on the vertical direction is reduced to 1/M of the original value, and the resolution on the horizontal direction is reduced to 1/N of the original value, and the overall resolution is decreased to 1/(M×N)=1/K (Formula (1)) of the original value.

Then, the stagger mixing of the images with multiple viewing angles could be implemented according to the following ways: along the row direction of the LEDs, the pixels of adjacent LED tubes come from the images, the angle between which is equal to M parallax angles. Along the column direction the LED, the pixels of adjacent LED tubes come from the images, the angle between which is equal to one parallax angle.

When the ratio of the horizontal spacing and the vertical spacing of the LED tubes of the display arrays is r, the angle between the optical gratings and the column direction of the LED arrays should be α=tan⁻¹(r/M) (Formula (2)), so as to ensure that the pixels observed through the optical gratings are from images with the same viewing angle; In this case, the magnification factor is

$$m = \frac{WM}{{p}_{h}} \qquad ( Formula ( 3 ) )$$

wherein W is the distance between observer's two eyes, and Pₕ is the spacing in the row direction between adjacent LED tubes; The width of a cell of the optical gratings is

$${p}_{μ} = \frac{m}{m + 1} \frac{{p}_{h}}{M} K cos α \qquad ( Formula ( 4 ) )$$

In the present invention, the distance between the observer's two eyes takes W=65 mm.

In the present invention, the optical gratings 13 (for example, slit gratings or lenticular gratings) may be placed in front of the display LED arrays in parallel. Assuming the distance between optical gratings and the LED display arrays is d, then the viewing distance for the naked eyes to get an optimal stereoscopic effect is: D=m×d wherein, m is the magnification factor.

FIG. 1 can be used as a detailed embodiment of the naked eye 3D TV wall implemented by full color LED arrays. In FIG. 1, the naked eye 3D TV wall of the present invention consists of full color LED display arrays 11 and optical gratings 13, (which are implemented by slit gratings or lenticular gratings etc.). The basic display unit of the LED arrays is a full color LED tube 12. The optical gratings 13 are placed in front of the LED display arrays, and parallel to the LED display arrays. There is a tilt angle between the direction of the optical gratings 13 and the column direction of the LED tubes. In order to generate a 2D (two-dimensional) display resolution of 800×600 pixels, 480,000 full color LED tubes to be arranged in the display arrays; and when the spacing of the LED tubes is 4 mm, the whole LED arrays occupy an area of about 3.2×2.4 square meters.

The basic unit of full color LED display arrays 11 is a full color LED tube 12. The LED tube 12, in fact, is formed by packaging three LED tubes, each of which presents one single color—Red, Green or Blue, into one tube. The full color LED tube may emit full color lights. The benefits of using the full color LED are that one color element can be displayed by only one LED tube, instead of three LED tubes. In the case of the same density of the LED arrays, the full color LED may provide a display resolution as big as at least three times of the display resolution of LED tubes each with a single color. As a 2D display shown, the full color LED tubes of the naked eye 3D TV wall are also arranged equidistantly and regularly on the display arrays.

FIG. 2 is a schematic diagram of a structural design of the optical gratings and a stagger mixing mode of images with multiple viewing angles in the case of 5 viewing angle image. The circle in FIG. 2 stands for a full color LED tube 12, and the serial number in each circle indicates that a pixel of the full color LED tube 12 comes from which serial number of image. As shown in FIG. 2, only a pixel belongs to the same image can be watched at one single observation position through slit gratings or lenticular gratings. As shown in dotted lines in FIG. 2, all watched pixels are from the 2^{nd} image. Since the optical gratings are placed obliquely, and the images with multiple viewing angles are mixed stagger in a corresponding manner, the loss of the display resolution is decomposed into the horizontal direction and the vertical direction. According to formula (1)-(5), the following data can be got:

Here, the amount of viewing angles K=5, M=2, N=2.5, i.e., the resolution on the horizontal direction is reduced to 1/2.5 of the original value, and the resolution on the vertical direction is reduced to ½ of the original value.

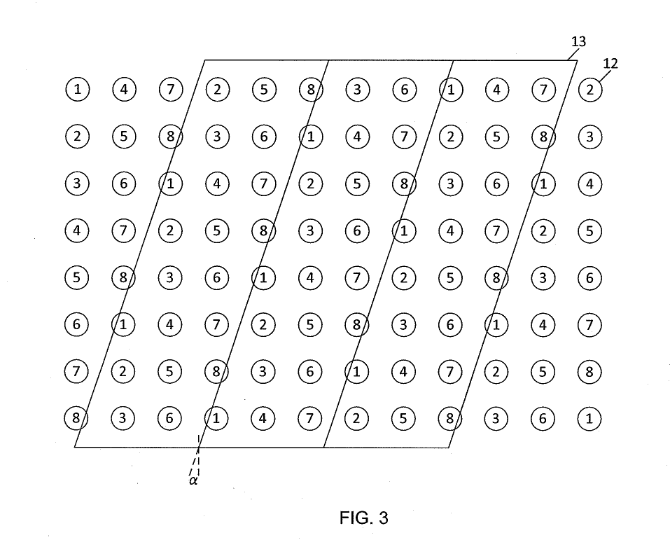

The stagger mixing mode of images with multiple viewing angles is as follows: along the row direction of the LEDs, the pixels of adjacent LED tubes come from the images, the angle between which is equal to M=2 parallax angles. Along the column direction of the LEDs, the pixels of adjacent LED tubes come from the images, the angle between which is equal to one parallax angle. When the LED tubes are arranged equidistantly and regularly along the horizontal direction and the vertical direction, the angle between the optical gratings 13 and the column direction of the LED arrays should be α=tan⁻¹(½). If the spacing in the row direction between adjacent LED tubes is Pₕ=4 mm and the distance between the observer's two eyes takes W=65 mm, the magnification factor is m=32.5. In this case, the width of each cell of the optical gratings is P_{μ}=8.677 mm. If the distance between the optical gratings and LED display arrays is d=100 mm, the viewing distance for the naked eyes to get an optimal stereoscopic effect is D=3.25 m. Comparing with the design of images with 8 viewing angles as shown in FIG. 3, the design of images with 5 viewing angles as shown in FIG. 2 has less loss of the display resolution. And the optimal observation distance is closer. However, it is a probability of ⅕ for the observer to get incorrect matching pairs of stereo images because the observer is in a position of transition region.

FIG. 3 is a schematic diagram of a structural design of the optical gratings and a stagger mixing mode of the images with multiple viewing angles in the case of an image with 8 viewing angles. FIG. 3 is similar to FIG. 2; the only difference is that FIG. 3 describes a structural design of the optical gratings and a stagger mixing mode of the images with multiple viewing angles in the case of an image with 8 viewing angles. It can be seen from the serial number of the circle of a LED tube 12, wherein a new stagger mixing layout of the pixels is applied. In this case, the amount of viewing angles is K=8, M=3, N=8/3. i.e., the resolution on the horizontal direction is reduced to ⅜ of the original value, and the resolution on the vertical direction is reduced to ⅓ of the original value. The stagger mixing mode of the images with multiple viewing angles is as follows: along the row direction of the LEDs, the pixels of adjacent LED tubes come from the images, the angle between which is equal to M=3 parallax angles. Along the column direction of the LEDs, the pixels of adjacent LED tubes come from the images, the angle between which is equal to one parallax angle. When the LED tubes are arranged equidistantly and regularly along the horizontal direction and the vertical direction, the angle between the optical gratings 13 and the column direction of the LED arrays should be α=tan⁻¹(⅓). If the spacing in the row direction between adjacent LED tubes takes Pₕ=4 mm and the distance between the observer's two eyes is W=65 mm, the magnification factor is m=48.75. In this case, the width of each cell of the optical gratings is p_{μ}=9.916 mm. If the distance between the optical gratings and LED display arrays is d=100 mm, the viewing distance for the naked eyes to get an optimal stereoscopic effect is D=4.875 m. As shown in FIG. 3, it is a probability of ⅛ for the observer to get incorrect matching pairs of stereo images for because the observer is in a position of transition region. The optimal viewing distance is a bit farther, but the loss of the display resolution is higher. In practice, the selection of viewing angles from 5 viewing angles or 8 viewing angles to another amount of viewing angles similarly depends on the balance of the loss of the display resolution and the occurrence possibility of a position of the display transition region of the viewing angles.

Hence one can see that the advantages of the present invention are as the following:

(1) In the present invention, when the images with multiple viewing angles are stagger mixed, parallel to the full color LED arrays, and displayed on the full color LED arrays; there is a tilt angle between the direction of the optical gratings and the column direction of the full color LED display arrays; therefore, when the images with multiple viewing angles are stagger mixed and then are displayed on the full color LED arrays, because of the obscuration effect or the refraction effect of optical gratings, the loss of the display resolution is allowed to be decomposed into the horizontal direction and the vertical direction. And then the left eye and the right eye of the observer watch different images so as to form a stereoscopic image in the brain. Then the observer can watch 3D images on the TV wall without wearing special glasses.

(2) A full color LED tube is applied as the basic unit in the present invention, thus In the case of the same density of the LED arrays, full color LED tubes provide a display resolution much higher than LED tubes each with a single color.

The above-mentioned are only preferred embodiments of the present invention, and are not intended to limit the invention. The present invention of any modification, equivalent replacement, improvement, etc. where is within the spirit and principle, should be deemed to be within the scope of the present invention.

What is claimed is:

1. A naked eye 3D TV wall, characterized in that the naked eye 3D TV wall consists of full color LED display arrays and optical gratings; wherein, the optical gratings are placed in front of the full color LED display arrays, parallel to the full color LED display arrays, and keep a certain distance away from the full color LED display arrays; there is a tilt angle between the direction of the optical gratings and the column direction of the full color LED display arrays; when the images with multiple viewing angles are stagger mixed and then are displayed on the full color LED arrays, the loss of the display resolution is allowed to be decomposed into the horizontal direction and the vertical direction; and thus, the observer can watch 3D images on the TV wall without wearing special glasses.

2. The naked eye 3D TV wall of the claim 1, characterized in that the stagger mixing of the images with multiple viewing angles can be implemented in the following way:
along the row direction of the LEDs, the pixels of adjacent LED tubes come from the images, the angle between which is equal to M parallax angles; along the column direction of the LEDs, the pixels of adjacent LED tubes come from the images, the angle between which is equal to one parallax angle; Wherein, integers N and M satisfy M×N=K, 1<M<K, and N=K/M, K is the amount of viewing angles.

3. The naked eye 3D TV wall of the claim 2, characterized in that when the ratio of the horizontal spacing and the vertical spacing of the LED tubes of the display arrays is r, the angle between the optical gratings and the column direction of the LED arrays should be α=tan⁻¹(r/M); and thus, the magnification factor is
$$m = \frac{WM}{{p}_{h}} ,$$
wherein W is the distance between the observer's two eyes; And pₕ is the spacing in the row direction between adjacent LED tubes.

4. The naked eye 3D TV wall of the claim 3, characterized in that the width of a cell of the optical gratings is
$${p}_{μ} = \frac{m}{m + 1} \frac{{p}_{h}}{M} K cos α .$$

5. The naked eye 3D TV wall of the claim 3, characterized in that the distance between the observer's two eyes takes W=65 mm,

6. The naked eye 3D TV wall of the claim 1, characterized in that, the basic unit of display arrays is a full color LED tube; wherein the full color LED tube is formed by packaging three LED tubes, each of which presents one single color—Red, Green or Blue, into one tube; and it can emit full color lights.

7. The naked eye 3D TV wall of the claim 1 or 2, characterized in that the LED tubes are arranged equidistantly and regularly in the display arrays along the horizontal direction and the vertical direction.

8. The naked eye 3D TV wall of the claim 1 or 2, characterized in that the optical gratings in front of the LED display arrays are slit gratings or lenticular gratings.

9. The naked eye 3D TV wall of the claim 8, characterized in that the slit gratings or lenticular gratings are placed in front of the display LED arrays in parallel; when the distance between the optical gratings and the LED display arrays is d, the viewing distance for the naked eyes to get an optimal stereoscopic effect is: D=m×d, wherein, m is the magnification factor.
